(19) United States
(12) Patent Application Publication
(10) Pub. No.: US 2023/0284743 A1
(43) Pub. Date: Sep. 14, 2023

(54) Balanced Insole Structure with Massage Function

(71) Applicant: DONGGUAN QI QI CLOTHING CO., LTD, Dongguan (CN)

(72) Inventor: Jiqi Yin, Dongguan (CN)

(21) Appl. No.: 17/899,599

(22) Filed: Aug. 30, 2022

(30) Foreign Application Priority Data
Mar. 11, 2022 (CN) 202210239663.3

(51) Int. Cl. A43B 17/14

(52) U.S. Cl. CPC A43B 17/14

(57) ABSTRACT

A balanced insole structure with a massage function includes an insole main body and a connecting portion; the arch portion of the insole main body is provided with a convex portion matched with the curvature of the sole of the foot; the connecting portion is connected to two ends on the lower side of the convex portion, thus forming a stabilization cavity through their connection; and the insole main body is also provided with a massage protrusion on its upper surface. In the invention, the provision of the insole main body with the massage protrusion on its upper surface can realize the massage function of the insole.

### CROSS REFERENCE TO RELATED APPLICATIONS

The present application claims the benefit of Chinese Patent Application No. 202210239663.3 filed on Mar. 11, 2022, the contents of which are incorporated herein by reference in their entirety.

### TECHNICAL FIELD

The invention belongs to the technical field of insoles, and in particular to an insole structure.

### BACKGROUND ART

Currently, most of shoes on the market are worn to protect the feet when walking, keep the feet hygienic and clean, and at the same time protect the feet from being injured by foreign objects on the ground. Then, the common shoe production is mainly intended to attract the attention of consumers, so the shoes have a variety of beautiful and bright characteristic styles.

In addition, in order to increase the comfort of the shoes, insoles are provided in the shoes. The insoles are mainly molded with foaming materials, and then cut into a shape suitable for the inside of the shoes, so that consumers can have a comfortable feeling combined with softness when wearing shoes. However, the function of common insoles is limited to this.

Generally, common insoles only have the function of softness and comfort without other benefits, resulting in a waste of resources. If one want to improve the efficacy of insoles, he can do as shown in Taiwan patent M344873 titled “insole structure” announced on Nov. 21, 2008, where the insole mainly has an arc-shaped pad body corresponding to the sole of the foot of the human body, the pad body is added with traces of mineral elements capable of emitting far-infrared rays, and many massage convex grains are protruded on the surface of the pad body.

However, although the above insole structure can achieve the characteristics of better corresponding to the sole of the foot of the human body when users wear and use it, and has the massage effect of the massage convex grains, it has been found in use that the massage convex grains of the pad body are actually laid for the arch portion of the foot where the acupoints are concentrated, which only adds a massage gimmick to the insole.

In view of the above problems, the prior art provides an insole used for arch correction and balance and stimulation of massage acupoints and meridians (Application Number 201420316689.4). The insole is shaped into arc form corresponding to the heel and the arch of the human body. The upper part of the insole is provided with a massage protrusion portion for the heel of the foot and is protrudingly distributed with massage convex grains for the arch of the foot. An insole provided by the technology, used for arch correction and balance and stimulation of massage acupoints and meridians, is ergonomic in wearing and using and is preferably designed to fit the heel and arch of the foot, so that the user can wear it more comfortably, and at the same time the insole can use the protrusion portion and the convex grains to massage the heel and the arch of the foot and has an increased practical benefit in its overall implementation and use.

Although the above structure can solve the above problems existing in the prior art, it remains to be improved in the structural stability.

### SUMMARY OF THE INVENTION

In order to solve the above problems, the invention aims chiefly to provide a balanced insole structure with a massage function which not only has the massage function, but also has good structural stability, long service life, and is convenient for widespread promotion.

In order to realize the above objectives, the technical solutions of the invention are as follows.

A balanced insole structure with a massage function, including an insole main body, characterized in that it also includes a connecting portion; the arch portion of the insole main body is provided with a convex portion matched with the curvature of the sole of the foot; the connecting portion is connected to two ends on the lower side of the convex portion, thus forming a stabilization cavity through their connection; and the insole main body is also provided with a massage protrusion on its upper surface. In the invention, the provision of the insole main body with the massage protrusion on its upper surface can realize the massage function of the insole. In addition, the provision of the arch portion of the insole main body with the convex portion matched with the curvature of the sole of the foot, can well fit the curvature of the sole of the foot and improve the adaptability and comfort in use of the insole structure. The design of the connecting portion plays an important role in the stability of the insole. The connection of the connecting portion to the two ends on the lower side of the convex portion leads to the expansion of the two ends on the lower side of the convex portion toward both sides when the sole of the foot of a user squeezes the convex portion. At this time the connecting portion will exert a pull effect on the two ends on the lower side of the convex portion, thereby preventing the deformation and failure of the insole resulting from the excessive expansion of the two ends on the lower side of the convex portion, which greatly improves the overall stability of the insole structure, prolongs the service life, and is convenient for widespread promotion.

Specifically, the insole main body is provided with a convex portion to form a 3D three-dimensional arched mechanism with an arched arc height of 14±10 mm, and the upper surface of the insole main body is provided with a non-woven fabric layer. More specifically, the insole main body includes an outer waist surface on the upper side and an inner waist surface on the lower side, with the outer waist surface having an arched arc height of 19.5±10 mm, and with the inner waist surface having an arched arc height of 16±10 mm.

Further, the connecting portion is in the shape of a sheet, and is connected to all around the lower side of the convex portion to form a closed stabilization cavity. The arrangement of the above structure can further improve the strength of the overall structure of the insole, and the closed stabilization cavity can also be used to mount other structures. Specifically, the structure arrangement can also be arranged as an open stabilization cavity, and namely the connecting portion is only connected to the front and rear ends of the lower side of the convex portion.

Further, an elastomer is provided in the stabilization cavity. The provision of the elastomer in the stabilization cavity can ensure the normal operation of the convex portion for a long time without deformation and failure after a short time of stepping on it, so that the insole structure has a good overall stability and a long service life, and is convenient for widespread promotion.

Further, the elastomer is a spring which can well realize the reset of the convex portion, and has a simple structure, low production cost and long service life.

Further, there are provided multiple springs which are evenly distributed in the stabilization chamber, with the upper and lower ends of each spring fixedly connected to the upper wall and the lower wall of the stabilization chamber respectively.

Further, the massage protrusion is provided on the insole main body at a position corresponding to the Yongquan acupoint of the human body. The provision of the massaging protrusion on the insole main body at the position corresponding to the Yongquan acupoint of the human body, can realize the massage of the user's Yongquan acupoint when walking, so as to achieve a better massage effect.

Further, the massage protrusion is integrally formed with the insole main body. The integral formation of the massage protrusion with the insole main body can better ensure the strength and stability of the structure, facilitate processing, and reduce production cost.

Further, the massage protrusion is provided with a first magnetic member mounting groove which can be used to mount magnetic components, such as magnets, thereby realizing the magnetotherapy function while realizing the massage function.

Further, the front end of the insole main body is also provided with a massage protrusion which is provided with a second magnetic member mounting groove. The second magnetic member mounting groove can also be used to mount magnetic components, such as magnets, thereby realizing the magnetotherapy function while realizing the massage function.

Further, the upper surface of the insole main body is further provided with reinforcing bands which are distributed on the upper surface of the insole main body in a net shape. The design of the reinforcing strips can increase the overall stability of the insole structure, so that the insole structure is not easily deformed under stress and has high stability. The distribution of the reinforcing bands on the upper surface of the insole main body in a net shape can achieve the even distribution of the reinforcement effect of the reinforcing bands on the insole structure, which further enhances the structural stability of the insole structure. The insole main body and the reinforcing strips are made by integral injection of special nylon+carbon fiber material, with a thickness of 2.5-10 mm and a hardness of 30 D-100 D.

The advantages of the invention over the prior art lie in that, in the invention, the provision of the insole main body with massage protrusions on its upper surface can realize the massage function of the insole; in addition, the provision of the arch portion of the insole main body with the convex portion matched with the curvature of the sole of the foot, can well fit the curvature of the sole of the foot and improve the adaptability and comfort in use of the insole structure; the design of the connecting portion plays an important role in the stability of the insole; and the connection of the connecting portion to the two ends on the lower side of the convex portion leads to the expansion of the two ends on the lower side of the convex portion toward both sides when the sole of the foot of a user squeezes the convex portion, and at this time the connecting portion will exert a pull effect on the two ends on the lower side of the convex portion, thereby preventing the deformation and failure of the insole resulting from the excessive expansion of the two ends on the lower side of the convex portion, which greatly improves the overall stability of the insole structure, prolongs the service life and is convenient for widespread promotion.

### BRIEF DESCRIPTION OF THE DRAWINGS

FIG. 1 is a schematic top structure diagram of the invention.

FIG. 2 is a schematic bottom structure diagram of the invention.

FIG. 3 is a schematic side structure diagram of the invention.

FIG. 4 is a schematic view of the cross-sectional structure in the direction A1-A2 in FIG. 2.

### DETAILED DESCRIPTION OF THE INVENTION

In order for the objectives, technical solutions and advantages of the invention to be clearer, the invention will be further described in detail below in combination with the accompanying drawings and embodiments. It should be understood that the specific embodiments described herein are only used to explain the invention, but not to limit the invention.

In order to realize the above objectives, the technical solutions of the invention are as follows.

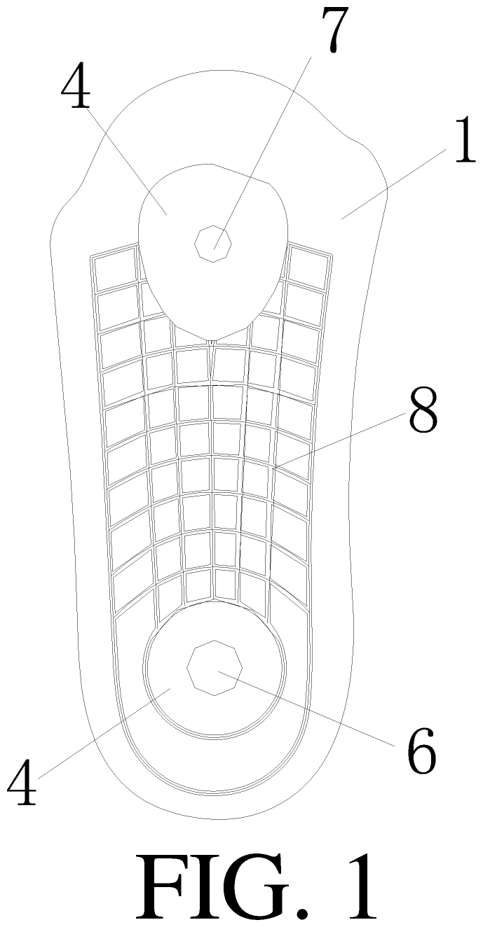

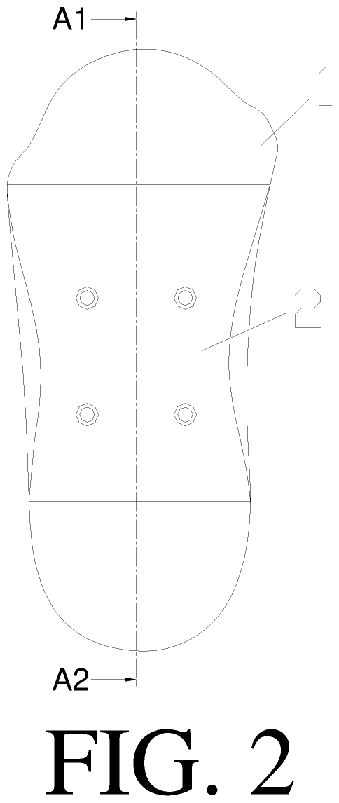

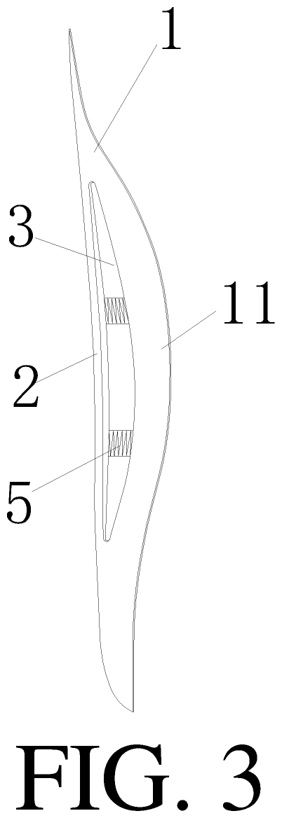

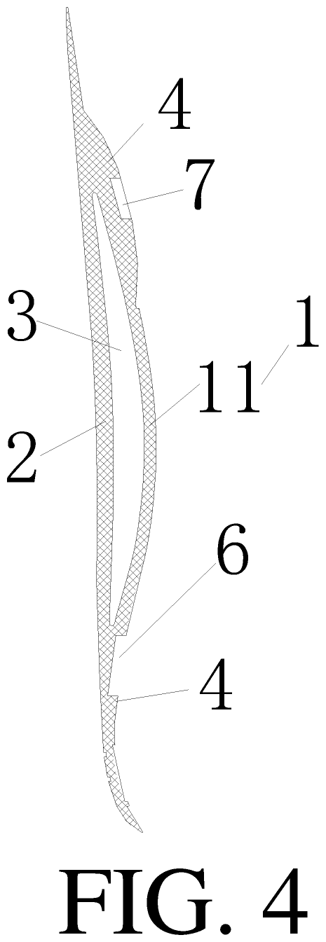

Referring to FIGS. 1 to 4, the invention provides a balanced insole structure with a massage function, including an insole main body 1 and a connecting portion 2. The arch portion of the insole main body 1 is provided with a convex portion 11 matched with the curvature of the sole of the foot. The connecting portion 2 is connected to two ends on the lower side of the convex portion 11, thus forming a stabilization cavity 3 through their connection. The insole main body 1 is also provided with a massage protrusion 4 on its upper surface. In the invention, the provision of the insole main body 1 with the massage protrusion 4 on its upper surface can realize the massage function of the insole. In addition, the provision of the arch portion of the insole main body 1 with the convex portion 11 matched with the curvature of the sole of the foot, can well fit the curvature of the sole of the foot and improve the adaptability and comfort in use of the insole structure. The design of the connecting portion 2 plays an important role in the stability of the insole. The connection of the connecting portion 2 to the two ends on the lower side of the convex portion 11 leads to the expansion of the two ends on the lower side of the convex portion 11 toward both sides when the sole of the foot of a user squeezes the convex portion 11. At this time the connecting portion 2 will exert a pull effect on the two ends on the lower side of the convex portion 11, thereby preventing the deformation and failure of the insole resulting from the excessive expansion of the two ends on the lower side of the convex portion 11, which greatly improves the overall stability of the insole structure, prolongs the service life, and is convenient for widespread promotion.

In the embodiment, an elastomer 5 is provided in the stabilization cavity 3. The provision of the elastomer 5 in the stabilization cavity 3 can ensure the normal operation of the convex portion 11 for a long time without deformation and failure after a short time of stepping on it, so that the insole structure has a good overall stability and a long service life, and is convenient for widespread promotion.

In the embodiment, the elastomer 5 is a spring which can well realize the reset of the convex portion 11 and has a simple structure, low production cost and long service life.

In the embodiment, there are provided multiple springs which are evenly distributed in the stabilization chamber 3, with the upper and lower ends of each spring fixedly connected to the upper wall and the lower wall of the stabilization chamber 3 respectively.

In the embodiment, the massage protrusion 4 is provided on the insole main body 1 at a position corresponding to the Yongquan acupoint of the human body. The provision of the massaging protrusion 4 on the insole main body 1 at the position corresponding to the Yongquan acupoint of the human body, can realize the massage of the user's Yongquan acupoint when walking, so as to achieve a better massage effect.

In the embodiment, the massage protrusion 4 is integrally formed with the insole main body 1. The integral formation of the massage protrusion with the insole main body 1 can better ensure the strength and stability of the structure, facilitate processing and reduce production cost.

In the embodiment, the massage protrusion 4 is provided with a first magnetic member mounting groove 6 which can be used to mount magnetic components, such as magnets, thereby realizing the magnetotherapy function while realizing the massage function.

In the embodiment, the front end of the insole main body 1 is also provided with a massage protrusion 4 which is provided with a second magnetic member mounting groove 7. The second magnetic member mounting groove 7 can also be used to mount magnetic components, such as magnets, thereby realizing the magnetotherapy function while realizing the massage function.

In the embodiment, the upper surface of the insole main body 1 is further provided with reinforcing bands 8 which are distributed on the upper surface of the insole main body 1 in a net shape. The design of the reinforcing strips 8 can increase the overall stability of the insole structure, so that the insole structure is not easily deformed under stress and has high stability. The distribution of the reinforcing bands 8 on the upper surface of the insole main body 1 in a net shape can achieve the even distribution of the reinforcement effect of the reinforcing bands 8 on the insole structure, which further enhances the structural stability of the insole structure.

The advantages of the invention over the prior art lie in that, in the invention, the provision of the insole main body 1 with massage protrusions 4 on its upper surface can realize the massage function of the insole; in addition, the provision of the arch portion of the insole main body 1 with the convex portion 11 matched with the curvature of the sole of the foot, can well fit the curvature of the sole of the foot and improve the adaptability and comfort in use of the insole structure; the design of the connecting portion 2 plays an important role in the stability of the insole; and the connection of the connecting portion 2 to the two ends on the lower side of the convex portion 11 leads to the expansion of the two ends on the lower side of the convex portion 11 toward both sides when the sole of the foot of a user squeezes the convex portion 11, and at this time the connecting portion 2 will exert a pull effect on the two ends on the lower side of the convex portion 11, thereby preventing the deformation and failure of the insole resulting from the excessive expansion of the two ends on the lower side of the convex portion 11, which greatly improves the overall stability of the insole structure, prolongs the service life, and is convenient for widespread promotion.

What is described above is only preferred embodiments of the invention and is not used to limit the invention. Any modifications, equivalent substitutions and improvements made within the spirit and principles of the invention shall be included in the protection scope of the invention.

What is claimed is:

1. A balanced insole structure with a massage function, including an insole main body, characterized in that it also includes a connecting portion; the arch portion of the insole main body is provided with a convex portion matched with the curvature of the sole of the foot; the connecting portion is connected to two ends on the lower side of the convex portion, thus forming a stabilization cavity through their connection; and the insole main body is also provided with a massage protrusion on its upper surface.

2. The balanced insole structure with a massage function according to claim 1, characterized in that the connecting portion is in the shape of a sheet, and is connected to all around the lower side of the convex portion to form a closed stabilization cavity.

3. The balanced insole structure with a massage function according to claim 1, characterized in that an elastomer is provided in the stabilization cavity.

4. The balanced insole structure with a massage function according to claim 3, characterized in that the elastomer is a spring.

5. The balanced insole structure with a massage function according to claim 4, characterized in that there are provided multiple springs which are evenly distributed in the stabilization chamber, with the upper and lower ends of each spring fixedly connected to the upper wall and the lower wall of the stabilization chamber respectively.

6. The balanced insole structure with a massage function according to claim 1, characterized in that the massage protrusion is provided on the insole main body at a position corresponding to the Yongquan acupoint of the human body.

7. The balanced insole structure with a massage function according to claim 6, characterized in that the massage protrusion is integrally formed with the insole main body.

8. The balanced insole structure with a massage function according to claim 7, characterized in that the massage protrusion is provided with a first magnetic member mounting groove.

9. The balanced insole structure with a massage function according to claim 8, characterized in that the front end of the insole main body is also provided with a massage protrusion which is provided with a second magnetic member mounting groove.

10. The balanced insole structure with a massage function according to claim 1, characterized in that the upper surface of the insole main body is further provided with reinforcing bands which are distributed on the upper surface of the insole main body in a net shape.
